(19) United States
(12) Patent Application Publication
(10) Pub. No.: US 2002/0169653 A1
(43) Pub. Date: Nov. 14, 2002

(54) System and method for obtaining customer information

(76) Inventors: David P. Greene, Ossining, NY (US); William Grey, Millwood, NY (US); Samuel Dinkin, Austin, TX (US); Paul A. Moskowitz, Yorktown Heights, NY (US); Philip Shi-lung Yu, Chappaqua, NY (US); Stephen J. Boies, Mahopac, NY (US); Edith H. Stern, Yorktown Heights, NY (US)

Correspondence Address: BUCKLEY, MASCHOFF, TALWALKAR, & ALLISON, 5 ELM STREET, NEW CANAAN, CT, 06840, US

(21) Appl. No.: 09/851,295

(22) Filed: May 8, 2001

(51) Int. Cl. G06F 17/60

(52) U.S. Cl. 705/10

(57) ABSTRACT

A system to obtain customer information includes detection of interactions of a customer within a retail store, and storage of customer interaction information representing the interactions in a portable customer device. In another aspect, a system to obtain customer information includes detection of customer interactions with an employee, and storage of customer interaction information representing the interactions in a portable customer device. The employee may be located within a retail store or elsewhere, such as a customer service telephone extension.

### BACKGROUND OF THE INVENTION

1. Field of the Invention

The present invention relates to systems for obtaining customer information. More specifically, the present invention concerns systems for detecting customer interactions and storing information concerning the customer interactions in an easily retrievable and usable manner.

2. Description of the Related Art

Retailers benefit by providing personal service to customers. Personal service in this context includes characteristics that are offered by a stereotypical “Mom and Pop” retail store. These characteristics include familiarity with customers on a first-name basis, knowledge of customers' likes and dislikes, and the ability to recall customers' prior transactions. A customer may be more likely to patronize a retailer who offers these characteristics than to patronize a retailer who does not. Moreover, customers are often willing to pay higher prices for products in exchange for such personal service. That is, a retailer offering personal service may be able to sell a product for a higher price than another retailer offering poorer service.

By providing personal service, a retailer is able to purchase and price inventory based on the retailer's knowledge of customer likes and dislikes. A retailer may also position inventory within a retail store in accordance with customer information obtained while providing personal service. For example, after learning that many customers who purchase hammers also desire handsaws, a retailer may decide to move his selection of handsaws closer to his selection of hammers. In another example, a retailer may use learned customer information to determine a special offer and to present the special offer to one or more particular customers depending on customer information associated with the particular customers. Generally, the information gleaned from customers through personal service enables a retailer to increase the efficiency of its retailing operation.

Modern retailers have found it difficult to provide customer service as described above. In particular, many modern retailers employ large sales staffs and experience high staff turnover. As a result, it is unlikely that a customer will interact with a same salesperson more than a few times. These retailers are therefore unable to obtain information that may be used to provide personal service to customers. Consequently, modern retailers do not experience the aforementioned benefits of personal service.

In view of the foregoing, what is needed is an efficient system to provide a retailer with customer information that may be used to provide personal service to customers and to experience the benefits flowing therefrom.

### SUMMARY OF THE INVENTION

In order to address the foregoing needs, the present invention provides a system, method, apparatus and medium to obtain customer information in which interactions of a customer within a retail store are detected, and customer interaction information representing the interactions is stored in a portable customer device. Several advantages result from this aspect of the present invention. First, the stored information may comprise a record of customer interactions accessible by the retailer or another retailer to provide personal service to the customer or to determine inventory, pricing or other retail variables. Also, by storing the customer interaction information on the portable customer device, the information does not need to be stored at the retailer.

In another aspect, the present invention relates to a system in which customer interactions with an employee are detected, and customer interaction information representing the interactions are stored in a portable customer device. The employee may be located within a retail store or elsewhere, such as a customer service telephone center. Accordingly, this aspect of the invention provides for capture of customer interaction information representing interactions that do not necessarily take place in a retail store. As described above, the customer interaction information may be accessed by and used by retailers to improve the efficiency of their operations.

The present invention also concerns a system for obtaining customer information in which a customer is detected within a retail store and customer interaction information associated with the customer is received from a portable customer device. Advantageously, such a system allows a retailer to unobtrusively identify and obtain information associated with customers. The information can then be used as described above to provide benefits to the retailer.

With these and other advantages and features that will become hereafter apparent, a more complete understanding of the nature of the invention can be obtained by referring to the following detailed description and to the drawings appended hereto.

### BRIEF DESCRIPTION OF THE DRAWINGS

FIG. 1 is a flow diagram of process steps to obtain customer interaction information according to embodiments of the present invention.

FIG. 2 is a topographic view of a network architecture according to embodiments of the present invention.

FIG. 3 is a block diagram of an internal architecture of a central system according to embodiments to the present invention.

FIG. 4 is a block diagram of an internal architecture of a portable customer device according to embodiments to the present invention.

FIG. 5 is a representative view of a tabular portion of a detected customer interaction database according to embodiments of the present invention.

FIG. 6 is a representative view of a tabular portion of a customer interaction information database according to embodiments of the present invention.

FIG. 7 is a flow diagram of process steps to obtain customer interaction information according to embodiments of the present invention.

FIG. 8 is a representative view of a portable customer device displaying a query to a customer according to embodiments of the present invention.

### DETAILED DESCRIPTION

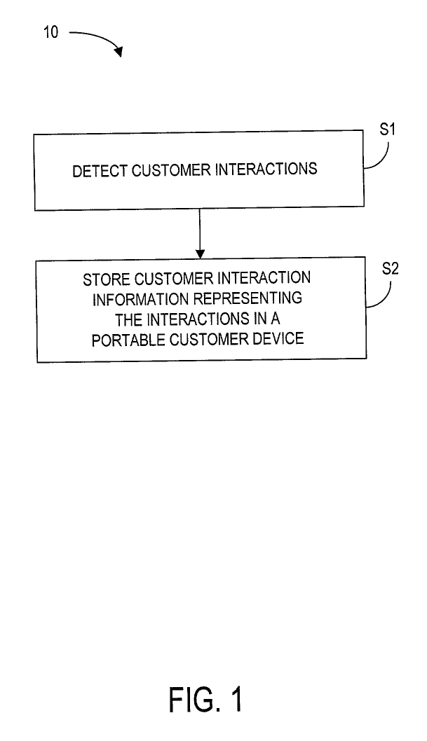

FIG. 1 is a flow diagram of process steps 10 to obtain customer interaction information according to embodiments of the present invention. In order to provide an immediate introduction to features of the present invention, process steps 10 will now be described without reference to a particular embodiment. Of course, a complete description of specific hardware and software embodiments of the claimed invention is set forth below.

Initially, in step S1, customer interactions are detected. The interactions may include entering a retail store, entering particular aisles or areas of a retail store for particular periods of time, standing in front of a product display, picking up a product, placing a product in a shopping cart, removing a product from a shopping cart, speaking with an employee, and purchasing a product. Of course, other interactions may be detected in step S1. It should be noted that the detected interactions need not occur in a retail store, but may include, for example, customer communications with a customer service representative via telephone, electronic mail, or another communication media. The interactions may be detected using known sensors, including microphones, cameras, barcode readers, pressure-activated sensors, and motion detectors. The sensors may be deployed in any manner by which customer interactions may be detected. Moreover, the interactions may be detected by a store employee and logged in a store-operated device.

Next, in step S2, customer interaction information representing the detected interactions is stored in a portable customer device. With reference to the example interactions listed above, the customer interaction information may include a date and time on which the customer entered the retail store, an amount of time spent in each aisle or area of the store, an amount of time spent in front of the product display, identities of products placed into and removed from the shopping cart, questions asked of the employee, and a method of payment. In one embodiment, the device is a Personal Digital Assistant (PDA) carried by the customer into the retail store. In another embodiment, the portable customer device is a card having a magnetic information strip affixed thereto.

The customer interaction information may be stored in the portable customer device in several ways. For example, the information may be transmitted to the device via a wireless protocol such as Bluetooth™ or via contact with a transmission station such as a kiosk or a card reader. The transmission may be directly intended for the device or broadcast to all portable customer devices.

By storing the information on a portable customer device, the retailer is not required to store information relating to each customer. Also, the stored information may be used to later identify a customer and to determine the identified customer's attitudes toward products and services offered by a retailer. As a result, the retailer may provide improved personal service to a customer and better determine how to price products and how to present the products to the customer.

Network Architecture

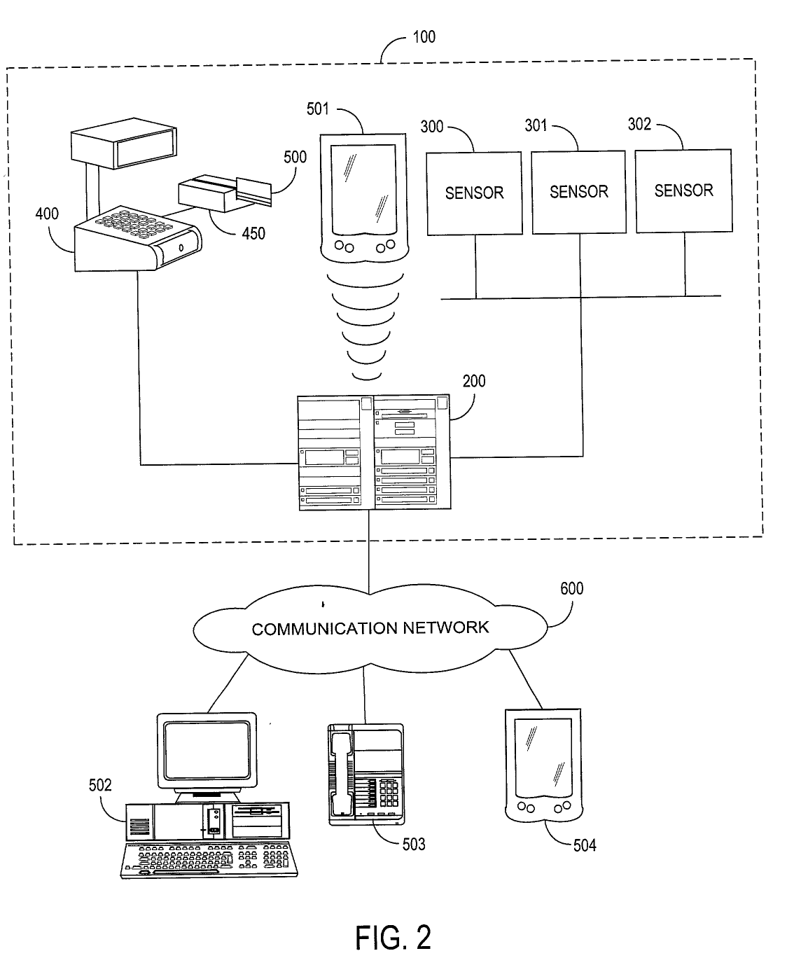

FIG. 2 is a topographic view of a network architecture according to embodiments of the present invention. Of course, network architectures other that that shown in FIG. 2 may be used to implement the invention.

The dotted rectangle shown in FIG. 2 represents a retail store according to one embodiment of the present invention. In the embodiment, each element enclosed by the dotted line is located within the retail store. Retail store 100 includes central system 200, sensors 300 to 302, cash register 400, card reader 450, and portable customer devices 500 and 501. As shown, portable customer device 500 is a card capable of storing data on a magnetic stripe, and portable customer device 501 is a PDA.

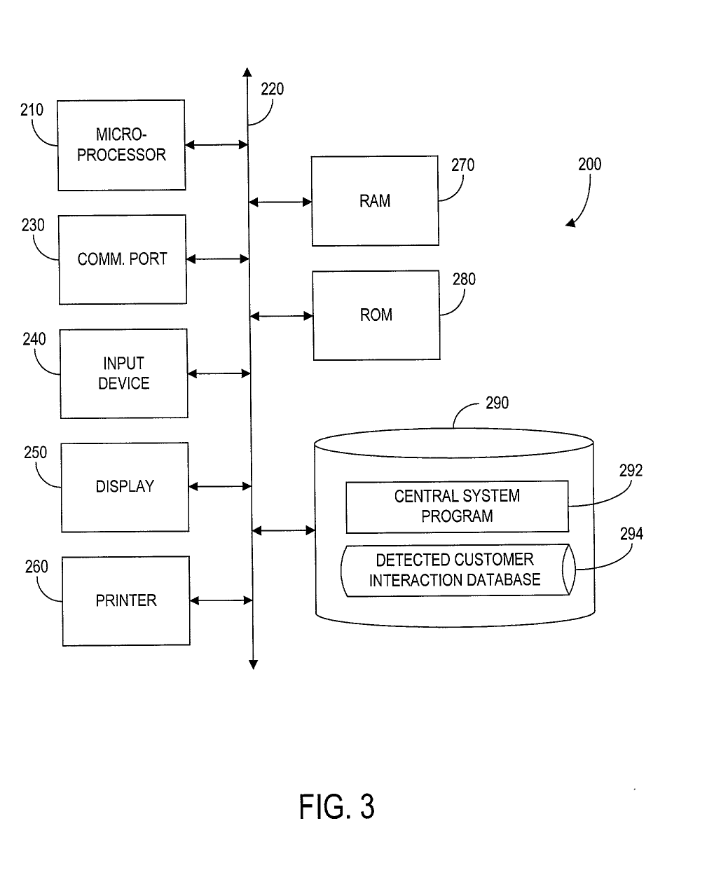

Central system 200 may comprise a mainframe computer, such as an IBM AS/400, or another computing device capable of performing the functions described herein. Central system 200 may control various operations of retail store 100, including inventory tracking, sales tracking, accounting, pricing, and employee scheduling. According to one embodiment, central system 200 operates to detect customer interactions and to store customer interaction information representing the interactions in a portable customer device. Details of central system 200 are set forth below with respect to FIG. 3.

In communication with central system 200 are sensors 300 to 302. Sensors 300 to 302 may comprise any combination of microphones, cameras, barcode readers, pressure-activated sensors, motion detectors, or other sensors for detecting customer interactions. Sensors 300 to 302 may be placed at any appropriate location within retail store 100, including, but not limited to, each store aisle, waiting rooms, product shelves, and kiosks. One or more of sensors 300 to 302 may also be placed outside of retail store 100, such as in an adjacent parking lot, along outdoor walkways, etc. In this regard, it is contemplated that more than three sensors may be used in accordance with the present invention.

Also in communication with central system 200 is cash register 400 and card reader 450. Cash register 400 and card reader 450 are used to execute customer purchases of products sold within retail store 100. In one example, a customer brings a product to an employee operating cash register 400, the employee inputs the price of the product into cash register 400, manually or using a bar code scanner, the customer slides a credit card through card reader 450, and the price is charged to a credit card account associated with the credit card. Card reader 450 may also be used to read and/or store customer interaction information from and/or to card 500.

Card 500 may comprise a frequent buyer card or a customer identification card. Card 500 may store information using a magnetic strip, a memory chip, a hologram or other currently or later-known means. As will be described below, customer interaction information may be stored on card 500 and read from card 500 by card reader 450, central system 200, or another device by wireless transmission, wireless broadcast, direct connection, or other means.

Customer interaction information may also be stored to and read from PDA 501. As shown, the information may be stored and read by central system 200 using a wireless system, but other systems described above may also be used. In one embodiment, a customer brings PDA 501 to retail store 100, the customer and/or PDA 501 is detected, customer interaction information is read from PDA 501, interactions of the customer are detected, and customer interaction information representing the detected interactions are stored in PDA 501 by central system 200.

It should be noted that the elements within retail store 100 may be connected differently than shown in FIG. 2. For example, some or all elements may be connected to one another by a network. In addition, retail store 100 may include elements embodying the present invention which are different from those shown.

Also shown in FIG. 2 is communication network 600 in communication with central system 200. Central system 200 communicates with customer devices 502 to 504 through communication network 600. As such, communication network 600 may comprise any number of systems for transferring data, including a local area network, a wide area network, a telephone network, a cellular network, a fiber-optic network, a satellite network, an infra-red network, a radio frequency network, and any other type of network which may be used to transmit information between devices. Additionally, communication network 600 may be used to transmit data using any known transmission protocol, such as Asynchronous Transfer Mode (ATM), Internet Protocol (IP), Hypertext Transfer Protocol (HTTP) and Wireless Application Protocol (WAP). In one embodiment, communication network 600 is the World Wide Web.

Customer devices 502 to 504 comprise a workstation, a telephone, and a PDA. Customer devices 502 to 504 may be used by central system 200 similarly to devices 500 and 501, for storing and reading customer interaction information. In this regard, a customer device usable in conjunction with the present invention includes any device capable of storing information and providing information. Of course, a customer device should be able to communicate with the device or devices with which it is intended to communicate over whatever type of network media exist between the devices.

Customer devices 502 to 504 may also be used by a customer to interact with an entity operating retail store 100, such as through a customer service representative. These interactions may also be detected and stored on a portable customer device according to the present invention. In one embodiment, a customer operates customer device 503 to interact with a customer service representative. The interaction is detected by central system 200 and customer interaction information representing the interaction is stored on portable customer device 504. Upon subsequently entering retail store 100 with device 504, the device and/or the customer is detected and the stored customer interaction information is received from device 504.

It should be noted that the devices shown in communication with each other need not be constantly exchanging data. Rather, communication may be established when necessary and severed at other times or always available but rarely used to transmit data. Moreover, although the illustrated communication links between the components of FIG. 2 appear dedicated, it should be noted that each of the links may be shared by other components.

Central System

FIG. 3 is a block diagram of the internal architecture of central system 200 according to one embodiment of the invention. As illustrated, central system 200 includes microprocessor 210 in communication with communication bus 220. Microprocessor 210 may be a Pentium™, RISC™-based, or other type of processor and is used to execute processor-executable process steps so as to control the components of central system 200 to provide functionality according to embodiments of the present invention.

Also in communication with communication bus 220 is communication port 230. Communication port 230 is used to transmit data to and to receive data from devices external to central system 200. Communication port 230 is therefore preferably configured with hardware suitable to physically interface with desired external devices and/or network connections. In one embodiment, customer interaction information is transmitted to and received from portable customer devices over communication port 230.

Input device 240, display 250 and printer 260 are also in communication with communication bus 220. Any known input device may be used as input device 240, including a keyboard, mouse, touch pad, voice-recognition system, or any combination of these devices. Input device 240 may be used by a retailer to input product information, commands to detect customer interactions, commands to receive customer interaction information from a portable customer device, or commands to output a listing of customer interaction information associated with a customer. In some embodiments, a store employee detects customer interaction information and stores the information using input device 240. Of course, such information may also be input to central system 200 via communication port 230.

Information may be output to an operator using display 250, which may be an integral or separate CRT display, flat-panel display or the like. Display 250 is generally used to output graphics and text to an operator in response to commands issued by microprocessor 210. Printer 260 may also output graphics and text, but in hardcopy form using ink-jet, thermal, dot-matrix, laser, or other printing technologies.

RAM 270 is connected to communication bus 220 to provide microprocessor 210 with fast data storage and retrieval. In this regard, processor-executable process steps being executed by microprocessor 210 are typically stored temporarily in RAM 270 and executed therefrom by microprocessor 210. ROM 280, in contrast, provides storage from which data can be retrieved but to which data cannot be stored. Accordingly, ROM 280 is used to store invariant process steps and other data, such as basic input/output instructions and data used during system boot-up or to control communication port 230. It should be noted that one or both of RAM 270 and ROM 280 may communicate directly with microprocessor 210 instead of over communication bus 220.

Data storage device 290 stores, among other data, central system program 292 of processor-executable process steps. Microprocessor 210 executes process steps of central system program 292 in order to control central system 200 to obtain customer information in accordance with the present invention. More specifically, the process steps of central system program 292 may be executed by microprocessor 210 to detect customer interactions, and to store customer interaction information representing the interactions in a portable customer device. As described above, the process steps of central system program 292 may also be executed by microprocessor 210 to detect a customer within a retail store and to receive customer interaction information associated with the customer from a portable customer device.

The process steps of central system program 292 may be read from a computer-readable medium, such as a floppy disk, a CD-ROM, a DVD-ROM, a Zip™ disk, a magnetic tape, or a signal encoding the process steps, and then stored in data storage device 290 in a compressed, uncompiled and/or encrypted format. In alternative embodiments, hard-wired circuitry may be used in place of, or in combination with, processor-executable process steps for implementation of the processes of the present invention. Thus, embodiments of the present invention are not limited to any specific combination of hardware and software.

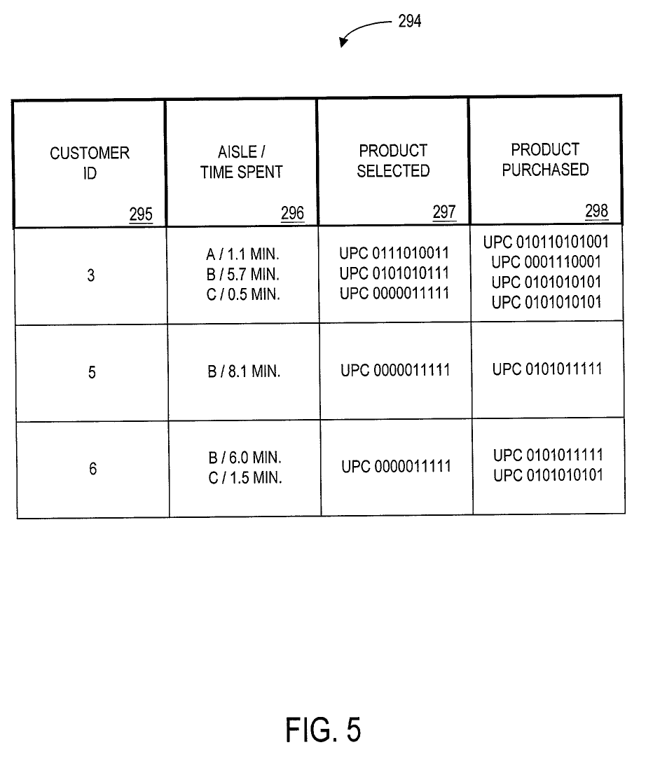

Data storage device 290 also stores detected customer interaction database 294. Detected customer interaction database 294 stores information representing customer interactions detected by central system 200 through sensors 300 to 302. A specific example of such information is described in detail below with reference to FIG. 5.

Stored in data storage device 290 may also be other unshown elements that may be necessary for operation of central system 200, such as other applications, other data files, an operating system, a database management system and “device drivers” for allowing microprocessor 210 to interface with devices in communication with communication port 230. For example, data storage device 290 may include process steps of an interactive voice response system enabling central system 200 to receive and respond to customer inquiries received from customer device 503. Also included may be process steps of a World Wide Web server enabling central system 200 to communicate with devices over the World Wide Web. These elements are known to those skilled in the art, and are therefore not described in detail herein.

Portable Customer Device

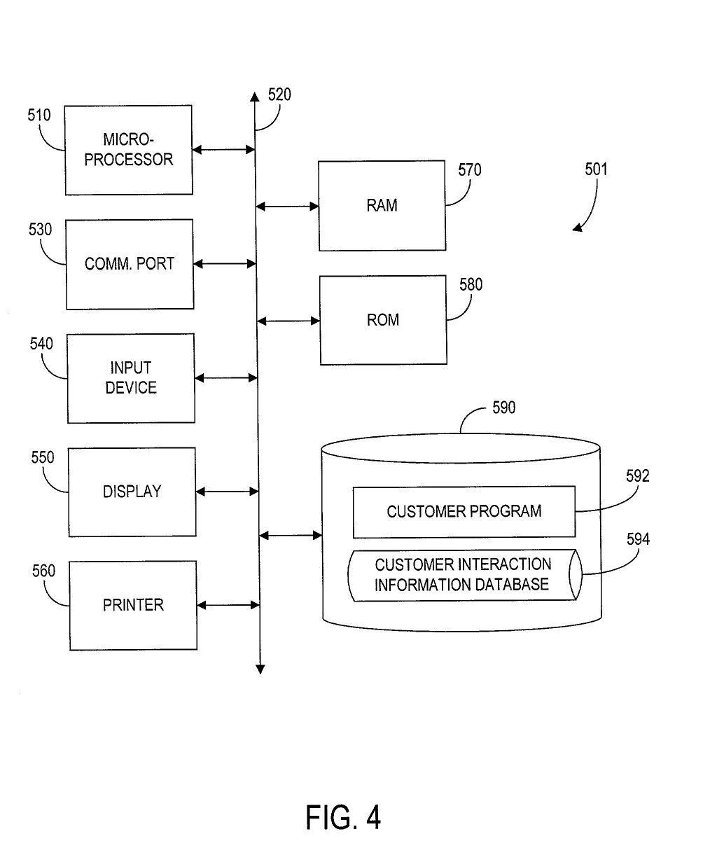

FIG. 4 illustrates several components of portable customer device 501 according to one embodiment of the invention. The components may comprise any of the specific examples set forth above with respect to identically-named components of central system 200. Of course, specific functions performed by the components may differ from the functions performed by the identically-named components.

For example, communication port 530 may be used to receive customer interaction information from and to transmit customer interaction information to central system 200. Also, input device 540 may be operated by a customer to edit customer interaction information stored in customer device 501, display 550 may be used to display customer interaction information or queries received from central system 200 to the customer, and printer 560 may be used to output a list of customer interaction information stored in device 501 and therefore associated with the customer. Input device 540, display 550 and printer 560 may also be used in conjunction with other applications provided by customer device 501 which are unrelated to the present invention.

Data storage device 590 stores customer program 592 of processor-executable process steps. The process steps of customer program 592 may be executed by microprocessor 510 so as to control portable customer device 501 to receive customer interaction information and/or to transmit stored customer interaction information over communication port 530. The process steps of customer program 592 may be read from a computer-readable medium, such as a floppy disk, a CD-ROM, a DVD-ROM, a Zip™ disk, a magnetic tape, or a signal encoding the process steps, and then stored in data storage device 590 in a compressed, uncompiled and/or encrypted format. In alternative embodiments, hard-wired circuitry may be used in place of, or in combination with, processor-executable process steps for implementation of the processes of the present invention.

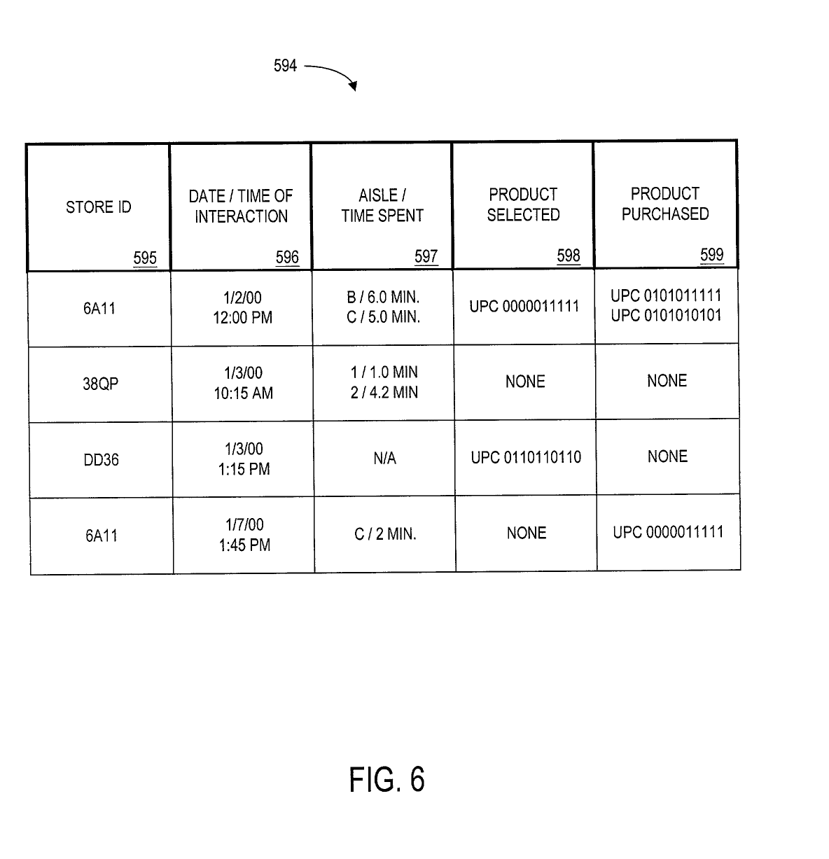

Also stored in data storage device 590 is customer interaction information database 594. Customer interaction information database 594 stores information representing interactions detected by central system 200 and transmitted to portable customer device 501. The information may be retrieved from customer interaction database 594 and transmitted to central system 200 upon entering retail store 100. In some embodiments, the information is received from central system 200 of retail store 100 and transmitted to a device operated by another retail store once portable customer device 501 enters the other retail store. One specific example of information that may be stored in customer interaction information database 594 is described with respect to FIG. 6.

Data storage device 590 may also store application files, data files and system files other than those shown in FIG. 4. These files may be used to provide a customer with functionality other than that provided by the present invention.

Detected Customer Interaction Database

A tabular representation of a portion of detected customer interaction database 294 is shown in FIG. 5. Some or all of the information stored in detected customer interaction database 294 is obtained from sensors such as sensors 300 to 302 of FIG. 1. The information may be obtained from other sources, such as from an employee operating input device 240 of central system 200.

As shown, detected customer interaction database 294 includes several records and associated fields. The fields include customer ID field 295, aisle/time spent field 296, product selected field 297 and product purchased field 298. Customer ID field 295 of a record specifies a customer whose interactions are represented by the record. According to the illustrated embodiment, the represented interactions are those detected during a single visit by the customer to retail store 100.

Aisle/time spent field 296 indicates the aisles of retail store 100 that the customer entered during the visit and how much time the customer spent in each aisle. To reduce an amount of less-valuable information in database 294, it may be beneficial to define a threshold minimum time which a customer must spend in an aisle before the aisle will be reflected in aisle/time spent field 296.

Product selected field 297 lists those products that were selected by the customer during the visit to retail store 100 but not purchased. Customer selection of a product may be detected by detecting those products in front of which the customer is positioned for at least a predetermined period, by detecting those products which the customer picks up, by detecting those products which the customer places in his shopping cart and later removes, by detecting other criteria, or by some or all of the above methods.

Finally, product purchased field 298 indicates those products purchased by a customer during the visit to retail store 100. To populate this field, the purchase interaction may be detected and the information to be stored in product purchased field 298 may be transmitted to central system 200 by cash register 400.

It is contemplated that detected customer interaction database 294 may include many more records than those shown and that each record may include fields other than those illustrated in FIG. 5. In this regard, database 294 may include fields representing customer traffic, customer preferences, personal characteristics and sales transaction information other than that represented by fields 296 to 298. Moreover, database 294 may include information representing interactions occurring at stores other than retail store 100. For example, central system 200 may receive from a portable customer device customer interaction information representing interactions detected by a central device operated by another retail store, and stored in the portable customer device by the central device.

Customer Interaction Information Database

FIG. 6 shows a tabular representation of a portion of customer interaction information database 594 according to embodiments of the invention. According to embodiments of the present invention, customer interaction information may be stored in database 594 and retrieved therefrom by central system 200. Moreover, the information may be used by retailers to provide improved service to customers and to increase efficiency of their retail operations.

Each record in the illustrated portion of customer interaction information database 594 includes store ID field 595, date/time of interaction field 596, aisle/time spent field 597, product selected field 598, and product purchased field 599. Store ID field 595 of a record specifies a retail store in which interactions represented by the record were detected. As shown in the illustrated portion, portable customer device 510 may store customer interaction information associated with more than one retail store. Date/time of interaction field 596 identifies a time associated with the represented interactions and may be, for example, a time of a first interaction of a visit. Fields 597 to 599 are similar to fields 296 to 298 of database 294. Of course, customer interaction information database 594 may include information other than the information shown in FIG. 6.

It should be noted that the tabular illustrations and accompanying descriptions of detected customer interaction database 294 and customer interaction information database 594 merely represent relationships between stored information. A number of other arrangements may be employed besides those suggested by the tables shown. Similarly, the illustrated entries of the databases represent sample information only; those skilled in the art will understand that the number and content of the entries can be different from those illustrated.

Specific Example

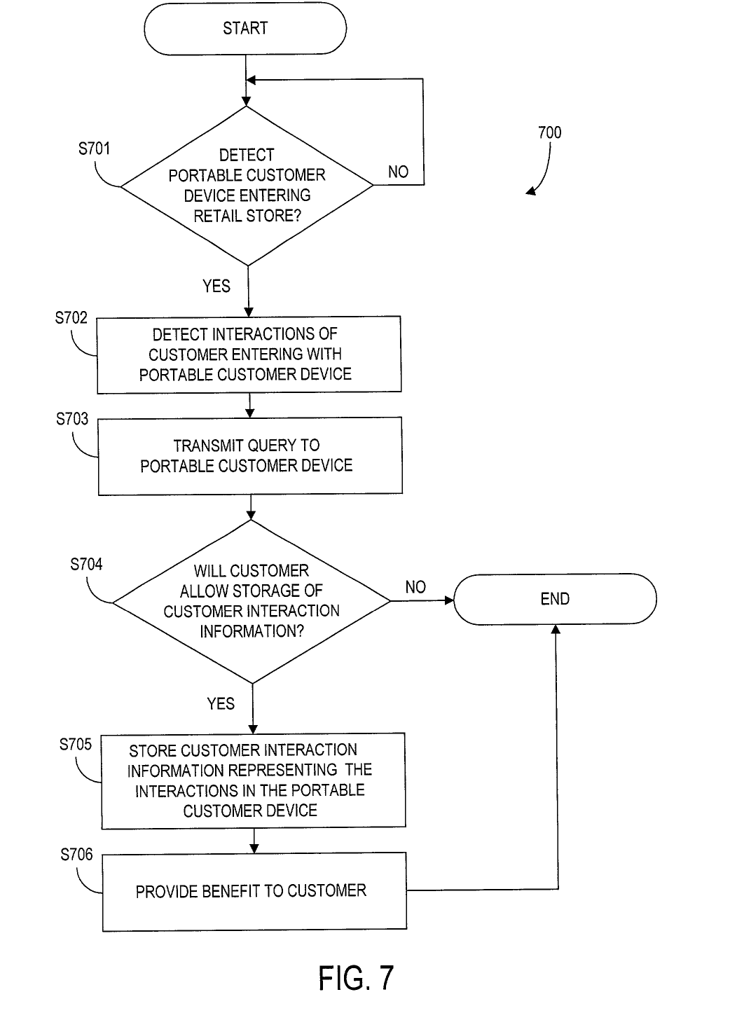

Process steps 700 of FIG. 7 set forth a process to obtain customer information according to an embodiment of the present invention. Process steps 700 are described herein as being included in central system program 292 and executed by microprocessor 210 so as to be performed by central system 200. Of course, it should be noted that process steps 700 may be performed by any device or by any number of devices in combination. Moreover, some or all of process steps 700 may be performed manually.

Process steps 700 begin at step S701, in which it is determined whether a portable customer device has been detected entering retail store 100. Flow pauses at step S701 until a portable customer device is detected. A portable customer device may be detected in any known manner. According to one embodiment, customer program 592 includes process steps enabling portable customer device 501 to detect a signal from central system 200 and to respond to the signal. Accordingly, central system 200 determines that portable customer device 501 has entered the retail store upon receiving a response to the signal. In other embodiments, a portable customer device may be detected in step S701 after communicating with a “check-in” kiosk within retail store 100, such as after detection of a passive transmitter such as a Mobil™ Speedpass™ included in the portable customer device.

In one embodiment, any or all of the wireless communication between devices such as central system 200, sensors 300 to 302, and portable customer device 501 includes the use of Bluetooth™ technology, which allows a wide range of computing and telecommunication devices to be interconnected via wireless connections. Each communicating device may be equipped with a microchip transceiver that transmits and receives over a previously unused frequency band of 2.45 GHz that is available globally (with some variation of bandwidth in different countries). Connections can be point-to-point or multipoint over a current maximum range of ten (10) meters.

Once a portable customer device is detected in step S701, flow proceeds to step S702. In step S702, interactions of a customer entering with the portable customer device are detected. As described above, many types of interactions may be detected in step S702 and information representing the interactions may be stored in detected customer interaction database 294 of central system 200. Detection may be carried out by sensors and/or by store employees operating store devices such as kiosks, PDA's, or central system 200 to store detected interactions in customer interaction database 294. According to one embodiment, detection of a portable customer device in step S701 includes detection of a customer ID transmitted by the device. The customer ID is then used in step S702 in order to associate a detected interaction with an appropriate customer in database 294.

After the interactions are detected, a query is transmitted to the portable customer device. The query may be transmitted by central system 200 after detecting that the customer is in a checkout line, at the beginning of a checkout process, after the customer has purchased items, or at any other time. In this regard, the query may be transmitted prior to step S702.

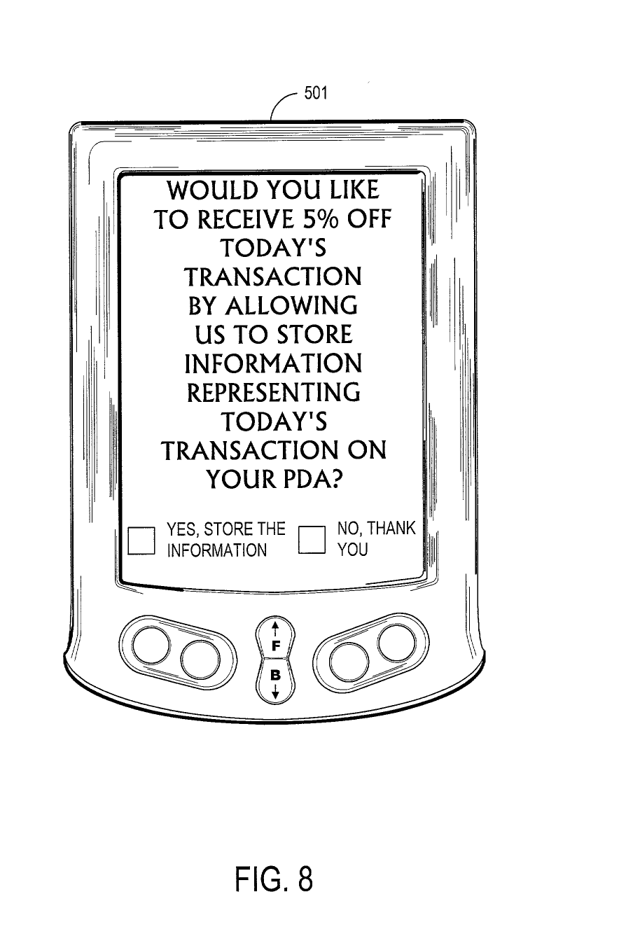

FIG. 8 is a view of portable customer device 501 after step S703. As shown, the transmitted query intends to determine whether the customer will allow central system 200 to store customer interaction information representing the detected interactions in portable customer device 501. The query also indicates that the customer will receive a benefit if the customer allows such storage. Accordingly, the customer uses input device 540 to indicate an affirmative or a negative response to the query.

Based on the customer's response to the query transmitted in step S703, it is determined in step S704 whether the customer will allow storage of customer interaction information in the portable customer device. If the customer will not allow such storage, process steps 700 terminate. Flow continues to step S705 if the customer allows storage of customer interaction information. In step S705, customer interaction information representing the detected interactions is retrieved from detected customer interaction database 294 and is stored in customer interaction information database 594. As shown in FIG. 6, the information may be stored in association with an identifier identifying retail store 100.

Next, in step S706, a benefit is provided to the customer. In the above example, the customer receives 5% off his purchase transaction. The benefit may be provided at cash register 400 or by adding a credit to a credit card account used to execute the purchase transaction. Of course, other benefits may be provided to the customer in exchange for storage of customer interaction information in his portable customer device. After step S706, process steps 700 terminate and the customer exits retail store 100 with his portable customer device.

It should be noted that the present invention may be embodied in process steps that vary significantly from process steps 700. For instance, some embodiments lack steps S703, S704 and S706. That is, a customer is not asked whether customer interaction information may be stored on his portable customer device prior to storing the information, and may not even realize that the information is stored. In other embodiments, card 501 is detected in step S701, the query is posed to the customer at checkout, and the customer interaction information is stored on card 501 by card reader 450. In still other embodiments, the customer may edit the customer interaction information stored on his portable customer device.

Once customer interaction information is stored in a portable customer device, the present invention contemplates detecting a customer within a retail store and receiving customer interaction information associated with the customer from a portable customer device. In some embodiments, the portable customer device is queried for the information and the information is transmitted in response to the query. The query and the customer interaction information may be transmitted and/or received in any of the manners described above, including direct or broadcast wireless transmissions, hardwired connections, and passive transmitters. Such an embodiment allows a retailer to identify and obtain information associated with a customer visiting a retail store. As mentioned above, the information can then be used to provide benefits to both the customer and the retailer.

Although the present invention has been described with respect to particular embodiments thereof, those skilled in the art will note that various substitutions may be made to those embodiments described herein without departing from the spirit and scope of the present invention.

What is claimed is:

1. A method for obtaining customer information, comprising:
detecting interactions of a customer within a retail store; and
storing customer interaction information representing the interactions in a portable customer device.

2. A method according to claim 1, wherein the storing step comprises:
transmitting the customer interaction information to the portable customer device.

3. A method according to claim 1, wherein the storing step comprises:
broadcasting the customer interaction information.

4. A method according to claim 1, wherein the customer enters the retail store with the portable customer device and exits the retail store with the portable customer device.

5. A method according to claim 1, further comprising:
receiving the customer interaction information from the portable customer device.

6. A method according to claim 1, further comprising:
detecting the portable customer device,
wherein the step of detecting customer interactions occurs only after the portable customer device is detected.

7. A method according to claim 1, further comprising:
detecting the portable customer device,
wherein the step of storing the customer interaction information occurs only after the portable customer device is detected.

8. A method according to claim 1, wherein the customer interaction information includes at least one of customer preferences, sales transaction information, and customer traffic information.

9. A method according to claim 1, wherein the customer may edit the stored customer interaction information.

10. A method according to claim 1, further comprising:
determining if the customer agrees to have the customer interaction information stored in the portable customer device; and
providing a benefit to the customer if the customer agrees to have the customer interaction information stored in the portable customer device.

11. A method according to claim 1, wherein the customer interaction information is input by a store employee.

12. A method for obtaining customer information, comprising:
detecting customer interactions with an employee; and
storing customer interaction information representing the customer interactions in a portable customer device.

13. A method according to claim 12, wherein the storing step comprises:
transmitting the customer interaction information to the portable customer device.

14. A method according to claim 12, wherein the storing step comprises:
broadcasting the customer interaction information.

15. A method according to claim 12, further comprising:
detecting the customer within a retail store.

16. A method according to claim 15, further comprising:
receiving the customer interaction information from the portable customer device.

17. A method according to claim 16, further comprising:
querying the portable customer device for customer interaction information.

18. A method according to claim 17, wherein the querying step comprises:
transmitting a query to the portable customer device.

19. A method according to claim 17, wherein the querying step comprises:
broadcasting a query.

20. A method according to claim 12, wherein the customer interaction information includes at least one of customer preferences, sales transaction information, and customer traffic information.

21. A method according to claim 12, wherein the customer may edit the stored customer interaction information.

22. A method according to claim 12, further comprising:
determining if the customer agrees to have the customer interaction information stored in the portable customer device; and
providing a benefit to the customer if the customer agrees to have the customer interaction information stored in the portable customer device.

23. A method for obtaining customer information, comprising:
detecting a customer within a retail store; and
receiving customer interaction information associated with the customer from a portable customer device.

24. A method according to claim 23, further comprising:
querying the portable customer device for customer interaction information.

25. A method according to claim 24, wherein the querying step comprises:
transmitting a query to the portable customer device.

26. A method according to claim 24, wherein the querying step comprises:
broadcasting a query.

27. A method according to claim 23, wherein the receiving step further comprises:
receiving a transmission from the portable customer device.

28. A method according to claim 27, wherein the transmission is a wireless transmission.

29. A medium storing processor-executable process steps to obtain customer information, the process steps comprising:
a step to detect interactions of a customer within a retail store; and
a step to store customer interaction information representing the interactions in a portable customer device.

30. A medium according to claim 29, wherein the step to store comprises:
a step to transmit the customer interaction information to the portable customer device.

31. A medium according to claim 29, wherein the step to store comprises:
a step to broadcast the customer interaction information.

32. A medium according to claim 29, wherein the customer enters the retail store with the portable customer device and exits the retail store with the portable customer device.

33. A medium according to claim 29, the process steps further comprising:
a step to receive the customer interaction information from the portable customer device.

34. A medium according to claim 29, the process steps further comprising:
a step to detect the portable customer device,
wherein the step to detect customer interactions occurs only after the portable customer device is detected.

35. A medium according to claim 29, the process steps further comprising:
a step to detect the portable customer device,
wherein the step to store the customer interaction information occurs only after the portable customer device is detected.

36. A medium according to claim 29, wherein the customer interaction information includes at least one of customer preferences, sales transaction information, and customer traffic information.

37. A medium according to claim 29, wherein the customer may edit the stored customer interaction information.

38. A medium according to claim 29, the process steps further comprising:
a step to determine if the customer agrees to have the customer interaction information stored in the portable customer device; and
a step to provide a benefit to the customer if the customer agrees to have the customer interaction information stored in the portable customer device.

39. A medium according to claim 29, wherein the customer interaction information is input by a store employee.

40. A medium storing processor-executable process steps to obtain customer information, the process steps comprising:
a step to detect customer interactions with an employee; and
a step to store customer interaction information representing the customer interactions in a portable customer device.

41. A medium according to claim 40, wherein the step to store comprises:
a step to transmit the customer interaction information to the portable customer device.

42. A medium according to claim 40, wherein the step to store comprises:
a step to broadcast the customer interaction information.

43. A medium according to claim 40, the process steps further comprising:
a step to detect the customer within a retail store.

44. A medium, according to claim 43, the process steps further comprising:
a step to receive the customer interaction information from the portable customer device.

45. A medium according to claim 44, the process steps further comprising:
a step to query the portable customer device for customer interaction information.

46. A medium according to claim 45, wherein the step to query comprises:
a step to transmit a query to the portable customer device.

47. A medium according to claim 45, wherein the step to query comprises:
a step to broadcast a query.

48. A medium according to claim 40, wherein the customer interaction information includes at least one of customer preferences, sales transaction information, and customer traffic information.

49. A medium according to claim 40, wherein the customer may edit the stored customer interaction information.

50. A medium according to claim 40, the process steps further comprising:
a step to determine if the customer agrees to have the customer interaction information stored in the portable customer device; and
a step to provide a benefit to the customer if the customer agrees to have the customer interaction information stored in the portable customer device.

51. A medium storing processor-executable process steps, the process steps comprising:
a step to detect a customer within a retail store; and
a step to receive customer interaction information associated with the customer from a portable customer device.

52. A medium according to claim 51, the process steps further comprising:
a step to query the portable customer device for customer interaction information.

53. A medium according to claim 52, wherein the step to query comprises:
a step to transmit a query to the portable customer device.

54. A medium according to claim 52, wherein the step to query comprises:
a step to broadcast a query.

55. A medium according to claim 51, wherein the step to receive further comprises:
a step to receive a transmission from the portable customer device.

56. A medium according to claim 55, wherein the transmission is a wireless transmission.

57. An apparatus to obtain customer information, comprising:
a processor; and
a storage device in communication with said processor and storing instructions adapted to be executed by said processor to:
detect interactions of a customer within a retail store; and
store customer interaction information representing the interactions in a portable customer device.

58. An apparatus to obtain customer information, comprising:
a processor; and
a storage device in communication with said processor and storing instructions adapted to be executed by said processor to:
detect customer interactions with an employee; and
store customer interaction information representing the customer interactions in a portable customer device.

59. An apparatus, comprising:
a processor; and
a storage device in communication with said processor and storing instructions adapted to be executed by said processor to::
detect a customer within a retail store; and
receive customer interaction information associated with the customer from a portable customer device.
